(19) United States
(12) Patent Application Publication
(10) Pub. No.: US 2007/0016784 A1
(43) Pub. Date: Jan. 18, 2007

(54) Method of storing revocation list

(75) Inventor: Marc Vauclair, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,229

(22) PCT Filed: Apr. 26, 2004
(86) PCT No.: PCT/IB04/50513

§ 371 Date: Oct. 25, 2005

(30) Foreign Application Priority Data
Apr. 28, 2003 (EP) 03101156.2

(51) Int. Cl. H04L 9/00

(52) U.S. Cl. 713/176

(57) ABSTRACT

A device implementing DRM may contain local storage to hold a revocation list, especially if it is not permanently connected in order to retrieve this list. This device has limited storage capability. Traditionally the device stores the certificate revocation lists as distributed. This invention proposes to only store for each identifier that has been revoked a shorter representation of that identifier and optionally metadata to reduce the storage size required for the revocation list.

The invention relates to a method of facilitating access control to content, the method involving entities being identified by a unique identifier, the method further involving revocation of at least one unique identifier, where a revoked unique identifier is further referred to as revoked identifier, the method comprising maintaining a local revocation list of entries, each entry representing at least one revoked identifier.

The invention further relates to a generator method of issuing unique identifiers, comprising the step of generating a new unique identifier.

The invention further relates to a system for controlling access to content material, the system comprising entities being identified by unique identifiers, the system further being arranged to handle revocation of at least one unique identifier, the system comprising a local revocation list of entries, each entry representing at least one revoked identifier, the system further comprising a receiver for receiving a new revoked identifier, and an updater for updating the local revocation list with the received new revoked identifier.

The invention further relates to a device arranged to store a local revocation list of entries, each entry representing at least one revoked identifier, to receive a new revoked identifier, and to add an entry containing the new revoked identifier to the local revocation list.

Digital content, such as movies, television programs, music, text, and the like, can be copied repeatedly without quality loss. Copy protection is being used by the content owners to prevent unlimited copying. Also, content access control technology is being used in order to control which content can be accessed by the user, in which manner, and against which conditions. Systems implementing content access control technology are known as conditional access systems (CA) in the broadcast world, and as DRM (Digital Rights Management) in the Internet world.

Different technologies have been proposed, developed, or used to implement copy protection and content access control. Content material can be encrypted during transmission and/or when it is being recorded. Devices that are designed to decrypt and render encrypted content, should comply with the policy associated with the content. An example policy is to transfer content only to a different device if that different device is also compliant.

Recently new content protection systems have been introduced in which a set of devices can authenticate each other through a bi-directional connection. Examples of these systems are SmartRight from Thomson, and DTCP (Digital Transmission Content Protection, http://www.dtcp.com) from the Digital Transmission Licensing Administration (DTLA).

Based on this authentication, the devices will trust each other and this will enable them to exchange protected content. The trust is based on some secret, only known to devices that were tested and certified to have secure implementations. Knowledge of the secret is tested during the authentication protocol. The best solutions for these protocols are those which employ ‘public key’ cryptography, which use a pair of two different keys. The secret to be tested is then the secret key of the pair, while the public key can be used to verify the results of the test. Additionally, the public key can be used as a unique identifier to refer to the device. To ensure the correctness of the public key and to check whether the key-pair is a legitimate pair of a certified device, the public key is accompanied by a certificate, that is digitally signed by a Certification Authority, the organization which manages the distribution of public/private key-pairs for all devices. In a simple implementation the public/private key pair of the Certification Authority is hard-coded into the implementation of the device. In typical security scenarios, there are several different devices involved within a system, which might not all be implemented with equal levels of tamper-proofing.

Such a system should therefore be resistant to the hacking of individual devices. An attacker can discover and expose the private key of a certified consumer device. Once a key is known, the protocols can be attacked and the content copied directly from the connection or link, enabling uncontrolled and possibly illegal storing, copying and/or redistribution of digital content. A hacker can further copy or imitate the behavior of a valid device. He can also copy the device itself. This way, multiple devices with the same secret can be created.

An important technique to increase the resistance against hacking and illegally copied devices is the so-called revocation of hacked devices. Revocation means the withdrawal of the trust in such a hacked device. If every device contains a unique identifier, it is possible that only the device that has been attacked is disabled by means of revocation. The effect of revocation is that other devices in the network may change their behavior towards the revoked device. For example, they may no longer want to communicate with the revoked device.

Devices can be addressed by unique identifiers. In addition, other entities may also be addressed and optionally revoked by means of a unique identifier.

Revocation of an entity or device can be achieved by using a so-called revocation list, which is a list of identifiers of revoked entities. Identifiers of revoked entities are further referred to as revoked identifiers. Often, revoked identifiers will be accompanied by metadata such as a timestamp. A device that is to verify the trust of another device, needs to have an up-to-date version of the revocation list and needs to check whether the identifier of the other device is on that list. Revocation lists can be published and/or updated by one or more authorities. So-called revocation notices contain updated or new information about revoked identifiers. Revocation lists and revocation notices can be transmitted in a television program or by broadcast servers. They can also be added to a storage medium such as a DVD disk, or communicated over a network. Within a local network, they can be further distributed. Further distribution may include processing or selection steps based on the locally available knowledge about identifiers of connected devices.

One of the known implementations of a revocation list is to use a so-called black list of revoked identifiers. Other implementations use a white list of non-revoked identifiers or mixed solutions. The advantage of black lists is that the entities are trusted by default and the trust in them is only revoked, if their identifier is listed on the black list. Although a device might request an up-to-date version of the black list each time it is needed, in most cases a device stores a local revocation list for referencing in between updates of the list or for local processing. This enables access to the list even if the connection to a server is unavailable, for example because the connection is prone to hacker intervention or hacker interruption, unreliable, sometimes unavailable (e.g., to a wireless mobile device), or too slow.

It is common practice to store revocation notices in a revocation list. These revocation notices contain the identifier, often the public key, of the revoked entity. In addition, the identifier and accompanying metadata has been signed by the certification authority, and this signature is stored along with the public key and metadata. The size of a public key and the signature depend on functional requirements, and legal and technical conditions. A commonly used size for a public key is 128 bytes, and for a signature 256 bytes.

Revocation lists will be used mainly in consumer electronic devices. This means there may be millions of devices, in a price-sensitive market. It also indicates that even a low percentage of revocations already leads to a large list of revoked identifiers. Therefore the storage on CE devices of the revocation list is problematic.

The open copy protection system, as described by Michael Epstein and others (“Open Copy Protection System”, Phillips Research, Proposal to broadcast protection discussion group, Version 1.4, May 7, 2002, Michael A. Epstein, Michael S. Pasieka, http://www.eff.org/IP/Video/HDTV/bpdg-report/pdf/philips_ocps_bpdg1.4t.pdf) proposes a more efficient way to store only the revoked identifier, i.e., the public key, along with some metadata, but to omit the signature. This reduces the storage requirement of the local revocation list, but it still requires that each entry stores the public key of typically 128 bytes.

It is an object of the invention to provide a method of the kind set forth that further reduces the storage requirements of the revocation list in a device.

This object is achieved according to the invention by a method characterized in that the entries in the local revocation list are generated by applying a conversion step to the at least one unique identifier generating a shorter representation uniquely identifying that at least one unique identifier.

The conversion step enables the storage of a revocation list in a smaller memory, or it allows that more entries can be stored in the same amount of memory. Because the shorter representation is not protected by a signature anymore, any communication thereof should be protected. Although it is for this reason logical and probably safer to perform the conversion step in the device that stores the local revocation list, this is not a necessity.

An embodiment of the method according to the invention is defined in claim 2. The invention can advantageously be applied within the device itself. In this case the exposure of the shorter representation to a hacker is limited.

An embodiment of the method according to the invention is defined in claim 3. The local revocation list is used in order to verify the compliancy of an entity, i.e., the fact that an entity has not been revoked.

An embodiment of the method according to the invention is defined in claim 4. In this embodiment the conversion step consists of a one-way hash function. The advantage is that the reverse computation of the unique identifier from the hash is computationally very difficult.

An embodiment of the method according to the invention is defined in claim 5. This embodiment uses secure storage for the local revocation list. This makes it more difficult to reverse engineer or observe and therefore understand the internal functioning of a system. It is also more difficult to change and thereby circumvent the protection offered by a local revocation list.

The generator method according to the invention is characterized in that the generator method performs the conversion step of claim 1 on the new unique identifier, resulting in a shorter representation, the generator method rejecting the issuing of the new unique identifier if the shorter representation of the new unique identifier matches the shorter representation of any of the previously issued generated unique identifiers.

This generator method can be applied advantageously in that it further reduces the storage requirements of the revocation list in a device.

The generator method guarantees that the shorter representation, computed by the conversion step, will still uniquely identify the original revoked identifier. Because of this guarantee, different methods can be used for the conversion step, including methods which results in an even shorter representation. The size of the shorter representation is in effect only limited by the number of different entities that needs to be accommodated within the relevant system.

An embodiment of the generator method according to the invention is defined in claim 7. The generator method maintains a history list of the shorter representation of the previously issued unique identifiers. This enables the generator method to verify whether the shorter representation of a newly computed unique identifier matches the shorter representation of any of the previously issued unique identifiers.

The system according to the invention is characterized in that the entries in the local revocation list are generated by applying a conversion step to the received new revoked identifier generating a shorter representation uniquely identifying the received new revoked identifier.

An embodiment of the system according to the invention is defined in claim 9. The system may comprise and access device that controls access to content material. The access device has its own unique identifier, enabling a verification of the access device itself against the local revocation list.

The device according to the invention is characterized in that the device is further arranged to generate the entry in the local revocation list by applying a conversion step to the new revoked unique identifier generating a shorter representation uniquely identifying that new revoked identifier.

A computer program product according to the invention is characterized in that the computer program product is capable to implement the method as defined above.

These and other aspects of the invention will be further described by way of example and with reference to the drawings, wherein:

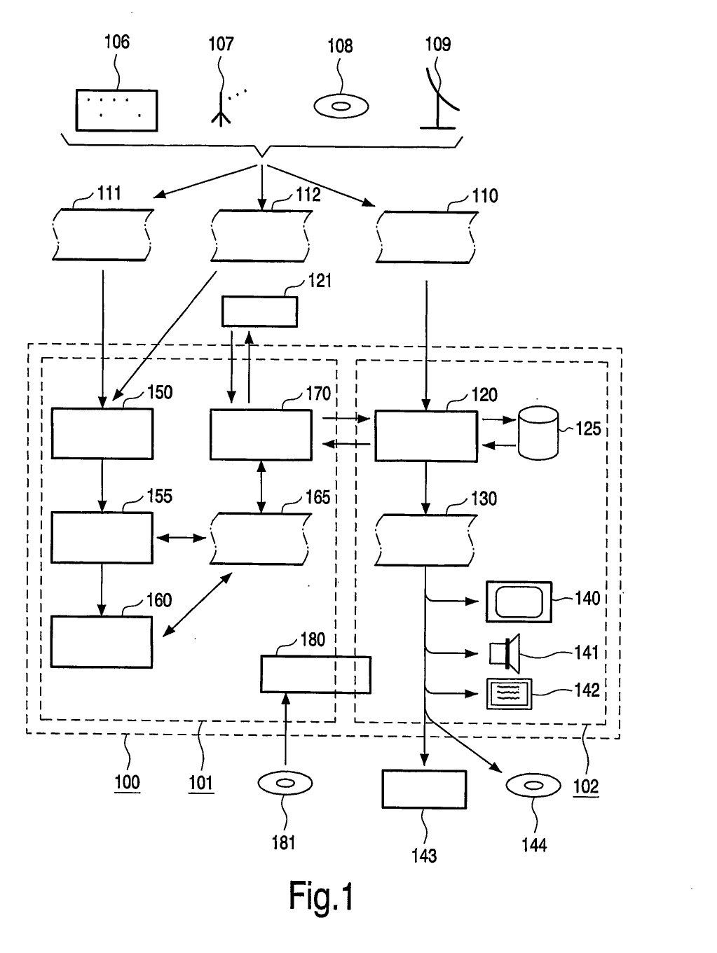

FIG. 1 schematically shows a system for controlling access to content material according to the invention,

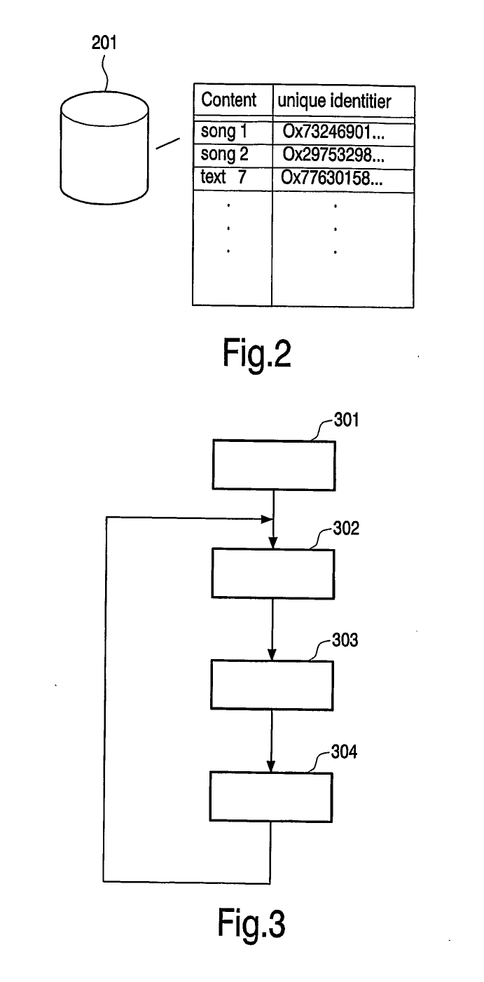

FIG. 2 shows the use of a unique identifier to identify content,

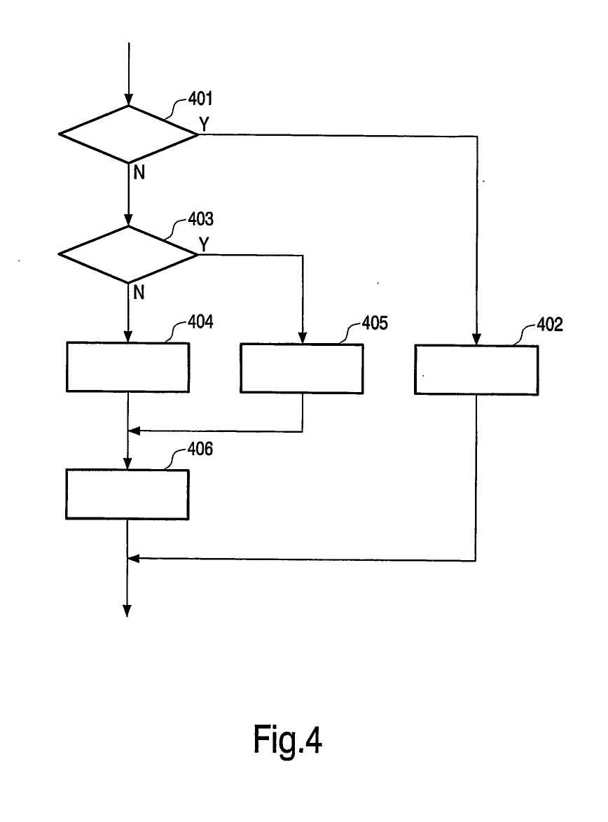

FIGS. 3 and 4 illustrate an example flow diagram for updating a local revocation list according to the invention,

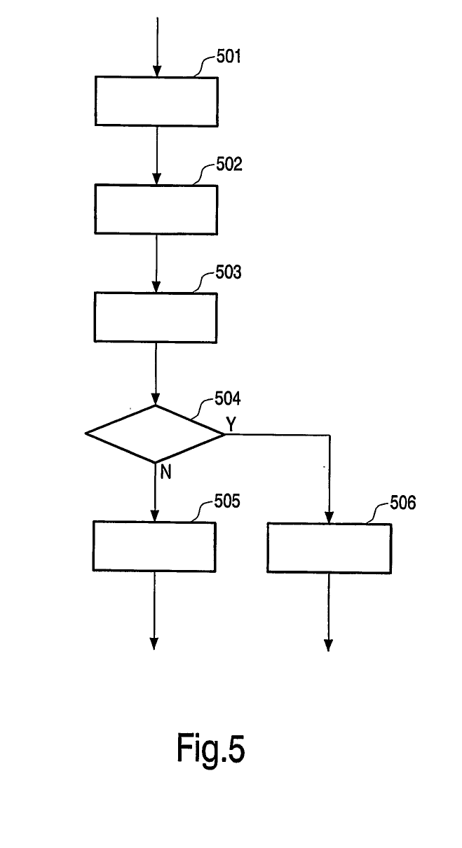

FIG. 5 shows an example flow diagram for the verification of a unique identifier against the local revocation list, and

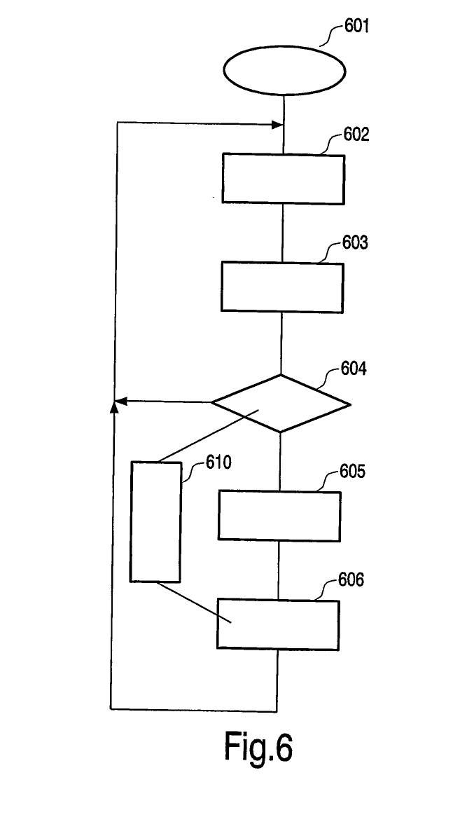

FIG. 6 shows a flow diagram for the generator method according to the invention for generating and issuing unique identifiers.

Throughout the figures, same reference numerals indicate similar or corresponding features. Some of the features indicated in the drawings are typically implemented in software, and as such represent software entities, such as software modules or objects.

FIG. 1 schematically shows a system 100. System 100 can be implemented as a dedicated device or as a set of devices. It may contain one or more processing units to implement the required functionality.

The data structures and program instructions for these processing units may be combined with the device(s) or may be stored and/or distributed on a medium 181 such as a CD-ROM. General-purpose devices such as a personal computer or PDA can also be used to implement the invention using a computer program product to distribute the program containing the invention.

The system 100 contains different subsystems 101 and 102.

Subsystem 101 relates to the handling of the local revocation list; subsystem 102 is able to control access to content material 110. Such an access control system 102 typically has an access device 120 that handles content material that can be obtained from different sources, such as a different device 106, local area network 107, physical distribution means such as a DVD disk 108, or a satellite dish 109.

The content material 110 can either be controlled content material or uncontrolled content material. Uncontrolled content material can either be content free of copyright, content from older media types, or content created or provided locally. Controlled content material can be copyrighted movies, copyrighted electronic books, a rented movie, a onetime movie and the like. Controlled content material can be accompanied by rules that specify which operations are allowed, possibly indicating traditional restrictions, such as a maximum number of copies that can be made, or a payment that is required to perform certain actions. For further protection against illegal handling the content material 110 can be (partially) encrypted.

Operations that can be performed by subsystem 102 include processing and rendering. Processing includes actions such as decoding, decrypting, and transcoding but also editing, timeshifting and archiving of content using a storage medium 125 such as a hard disk. Content containing program instructions can be processed by one or more dedicated or general-purpose processing units 180. These actions result in the availability of accessible content 130. This content can be rendered on an output device such as a television screen 140, audio speakers 141, or information display screen 142. This content can also be copied to a physical carrier such as a DVD+RW disk 144, or transmitted to a different device 143 or onto a network.

In order to protect the controlled content, devices in a network that handle controlled content should do so in accordance with certain policy requirements. For example, devices should authenticate each other before communicating content material. This prevents content from leaking to unauthorized devices. Some systems might also refuse to handle data originating from untrusted devices. It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or because the devices are provided with a certificate issued by a Trusted Third Party.

However, a device can be hacked or illegally copied by an adversary. An existing solution to cope with these hacked devices is device revocation. In general, revocation of a device is the reduction or complete disablement of one or more of its functions. For example, revocation of a CE device may place limits on the types of digital content that the device is able to decrypt and use. Alternatively, revocation may cause a piece of CE equipment to no longer perform certain functions, such as making copies, on any digital content it receives.

The usual effect of revocation is that other devices that know that a specific device is revoked will change their behavior towards the revoked device, for example they do not want to communicate anymore with the revoked device. A device may also have been informed that it is revoked itself; if the device consists of different parts some parts that are still complying may change their internal or external behavior accordingly. A device may also contain a processor and software, part of which could have been made more tamperproof (for example by storing its instructions in nonchangeable read-only memory), which implements a self-check in this manner.

Revocation of exactly one device can be done if every device has a unique identifier. This identifier can be for example its public key, but also a different unique identifier that is bound (for example via a certificate) to its public key.

Not only devices can be addressed by the range of unique identifiers. It is possible to identify all sorts of entities by a unique identifier. These other entities can therefore also be revoked in the same manner as devices. For example, the content itself (201) could carry a unique identifier for each song, text file, or picture, for example using a table 202 as shown in FIG. 2. In the sequel, revocation of a device or other entity will be addressed as revocation of an identifier. The identifier itself will be called revoked identifier.

Revocation of an identifier can be achieved in several different manners. Two different techniques are the use of a so-called black list (a list of revoked identifiers) or white list (a list of unrevoked identifiers, or a list of ranges of unrevoked identifiers). A device uses such a revocation list to verify whether an identifier has possibly been revoked.

A revocation list can either be downloaded completely each time it is needed, or downloaded once and be incrementally updated afterwards. Both revocation notices, containing new information about revoked identifiers, as well as complete revocation lists can be communicated to a device via several means, such as the normal communication channels for content, or by a dedicated connection such as a telephone connection, or the Internet. A revocation list typically consists of certificates, each certificate containing a public key, metadata, and signed by the certification authority. A typical size of the public key is 128 bytes.

Subsystem 101 shows a receiver 150 capable of receiving a revocation list 111 or a revocation notice containing a new received revoked identifier 112. When a revocation list 111 is received, it is possible to store the revocation list as a whole. However, the amount of storage required for this is often too large. The method according to the invention stores a shorter representation of the revoked identifiers.

The handling of a black list of revoked identifiers according to the invention will further be discussed in reference to FIG. 3 which shows the flow diagram for maintaining the local revocation list. In the initial situation 301, a local revocation list is stored. In step 302 a new revoked identifier is received. In step 303 a shorter representation of the new received revoked identifier is computed. The computation step is chosen such that it still uniquely identifies the new received revoked identifier. For example, the computation step may use knowledge about the identifier representation, in order to remove redundancy that is available in the identifier format. Also, the generator method used to generate the identifiers could be adapted such that a specific hash algorithm applied to the identifier still delivers unique shorter representations. This will be further described below in reference to FIG. 6. Step 304 updates the local revocation list with the shorter representation of the new received revoked identifier.

FIG. 4 further illustrates and details the update step 306. Step 401 verifies whether the shorter representation of the new revoked identifier is already present in the local revocation list. In that case, the information of the revoked identifier in the list is updated if required with for example a timestamp or other metadata in step 402. Otherwise, a check 403 is made whether free space is available in the local revocation list. If space is available, a free location is selected in step 404. Otherwise, step 405 selects an entry in the local revocation list that is to be replaced by the shorter representation of the new revoked identifier. Subsequently, step 406 stores the shorter representation of the received new revoked identifier at the selected location.

The verification of a unique identifier is further described in reference with the flow diagram shown in FIG. 5. In step 501 the unique identifier to be verified is received by the verification device. Step 502 computes the shorter representation of unique identifier to be verified. Step 503 searches for this shorter representation in the local revocation list. Step 504 decides whether a match has been found. If not found, it is assumed and reported in step 505 that the unique identifier has not been revoked. Otherwise, step 506 reports that the unique identifier has been revoked.

A further advantage of this method is that the storage requirements for a revocation entry are independent of the size of the public key hashed.

The principal of storing a shorter representation of a unique identifier can also be applied advantageously to other kinds of lists of identifiers. For example, co-pending patent application, filed under number EP 03101153.9 (attorney docket NL030430), shows how a list of unique identifiers that have been verified against the local revocation list is compiled. The storage required for this list can also be reduced by storing only the shorter representation of the verified unique identifiers according to this invention.

In a further embodiment the conversion step (304) consists of a one-way hash function. The advantage of this hash function is that the reverse computation of the unique identifier from the hash is computationally very difficult. The hash function must be chosen such that the shorter representations are unique. This could be done for example by not including the redundant information of the identifier in the input of the hash function.

One could also accept a situation where the shorter representation is not always unique, if the chance of having two equal shorter representation is sufficiently small. In that case, a revocation notice, converted into its shorter representation, may incidentally apply not only to the entity or device to be revoked, but may also apply to a device or entity with a different unique identifier which is converted into the same shorter representation. This requires a trade-off between the size of the shorter representation and the probability and consequences of incidentally revoking two devices.

In a further embodiment secure storage is used for the local revocation list. This makes it much more difficult for a hacker to read or change the contents of the local revocation list. This is important because the entries in this list are no longer protected by a signature of a trusted third party.

FIG. 6 shows a generator method according to the invention. This generator method is to be used in combination with the conversion step in the method of facilitating access control. The generator method generates and issues unique identifiers, such that the shorter representations generated by the conversion step, applied to of all of these unique identifiers, are all unique. More specifically, the generator method generates unique identifiers, but before issuing a newly generated unique identifier, it verifies whether its shorter representation as computed by the conversion step differs from all of the shorter representations of all previously issued unique identifiers. This process is shown in FIG. 6. From the initial situation 601, a new unique identifier is generated in step 602. Step 603 performs the conversion step resulting in a shorter representation. Step 604 verifies whether this shorter representation matches any of the shorter representations of previously issued un ique identifiers. This can be done for example by maintaining a history list 610 of given-away shorter representations. If the shorter representation of the newly generated unique identifier does not match, the newly generated unique identifier can be issued in step 605. Step 606 involves adding the shorter representation to the history list 610.

The history list could be a global list maintained by a central trusted party. Generation of identifiers could also be distributed by allowing each issuing party to issue only those unique identifiers of which the hash function starts with a certain prefix, the length of the prefix being smaller for parties that issue more unique identifiers, and the length of the prefix being larger for parties that issue less unique identifiers.

The above-mentioned embodiments illustrate rather than limit the invention. Those skilled in the art will be able to design many alternative embodiments without departing from the scope of the appended claims. In the claims, any reference signs placed between parentheses shall not be construed as limiting the claim. Instead of a random decision, also pseudo-random processes and other methods for generating unpredictability can be used. In the description above, “comprising” does not exclude other elements or steps, “a” or “an” does not exclude a plurality. A single processor, a suitably programmed computer, hardware comprising several distinct elements, or other unit may also fulfill the functions of several means recited in the claims. The mere fact that certain measures are recited in mutually different dependent claims does not indicate that a combination of these measures cannot be used to advantage.

1. A method of facilitating access control to content,
the method involving entities each being identified by a unique identifier,
the method further involving revocation of at least one unique identifier,
where a revoked unique identifier is further referred to as revoked identifier,
the method comprising maintaining a local revocation list (165) of entries,
each entry representing at least one revoked identifier, characterized in that
the entries in the local revocation list are generated by applying a conversion step to the at least one unique identifier generating a shorter representation uniquely identifying that at least one unique identifier.

2. The method according to claim 1, the method further comprising
receiving (302) a new revoked identifier (112),
performing the conversion step, and
subsequently updating the local revocation list with the generated shorter representation of the received new revoked identifier.

3. The method according to claim 1, the method further comprising a verification step in which a unique identifier is verified by
applying the conversion step to the unique identifier,
comparing the shorter representation of the unique identifier with the entries in the local revocation list, and
the unique identifier is considered to be revoked when the comparison finds a match between the shorter representation of the unique identifier and an entry in the local revocation list.

4. The method according to claim 1, wherein the conversion step comprises the computation of a hash of the at least one unique identifier, the hash becoming the shorter representation.

5. The method according to claim 1, wherein the method further comprises secure storing of the local revocation list.

6. A generator method of issuing unique identifiers, comprising the step of generating a new unique identifier, characterized in that
the generator method performs the conversion step of claim 1 on the new unique identifier,
resulting in a shorter representation,
the generator method rejecting the issuing of the new unique identifier if
the shorter representation of the new unique identifier matches
the shorter representation of any of the previously issued generated unique identifiers.

7. The generator method according to claim 6, wherein
the generator method maintains a history list of the shorter representation of the new unique identifier, and wherein
the generator method rejects the new unique identifier if
the shorter representation of the newly generated unique identifier matches
an entry in the history list.

8. A system (100) for controlling access to content material (110),
the system comprising entities being identified by unique identifiers,
the system further being arranged to handle revocation of at least one unique identifier,
the system comprising a local revocation list (165) of entries,
each entry representing at least one revoked identifier,
the system further comprising a receiver (150) for receiving a new revoked identifier (112), and
an updater (160) for updating the local revocation list with the received new revoked identifier, characterized in that
the entries in the local revocation list are generated by applying a conversion step to the received new revoked identifier generating a shorter representation uniquely identifying the received new revoked identifier.

9. The system (100) according to claim 8, in which the system further comprises
an access device (120) for controlling access to content material (110),
the access device being identified by a unique identifier,
the access of the access device to the content material is not being allowed if a match is found between
the shorter representation of the unique identifier of the access device, and
an entry in the local revocation list (165).

10. A device (101) arranged
to store a local revocation list (165) of entries,
each entry representing at least one revoked identifier,
to receive a new revoked identifier (112), and
to add an entry containing the new revoked identifier to the local revocation list,
characterized in that the device is further arranged to
generate the entry in the local revocation list by applying a conversion step to the new revoked unique identifier generating a shorter representation uniquely identifying that new revoked identifier.

11. A computer program product (181) capable to implement the method according to claim 1.
